(19) United States
(12) Patent Application Publication
(10) Pub. No.: US 2018/0079007 A1
(43) Pub. Date: Mar. 22, 2018

(54) Methods of Manufacturing Engine System Components

(71) Applicant: Caterpillar Inc., Peoria, IL (US)

(72) Inventors: Nan Yang, Brimfield, IL (US); Jeff A. Jensen, Dunlap, IL (US)

(73) Assignee: Caterpillar Inc., Peoria, IL (US)

(21) Appl. No.: 15/272,712

(22) Filed: Sep. 22, 2016

(51) Int. Cl. B22F 7/06; B23K 20/12; B23K 20/24; B22F 3/20; B22F 3/17; F01D 5/04; F16J 1/00; B21K 1/18

(52) U.S. Cl. CPC B22F 7/06; B23K 20/12; B23K 20/24; B22F 3/20; B23K 2201/003; F01D 5/04; F16J 1/005; B21K 1/18; B22F 3/17

(57) ABSTRACT

A method of making an engine system component is disclosed. The method may include loading a first metal-based material and a second metal-based material into an extrusion chamber. The first metal-based material may concentrically surround the second metal-based material, and the first metal-based material may have at least one of a thermal property and a wear resistance different than the second metal-based material. The method may additionally include forming an extrudate by simultaneously passing the first metal-based material and the second metal-based material through a die. The first metal-based material of the extrudate may be metallurgically bonded to the second metal-based material of the extrudate. The method may also include forging the extrudate.

### TECHNICAL FIELD

This disclosure generally relates to engine system components and, more particularly, to methods of manufacturing engine system components.

### BACKGROUND

Engine system components, such as, piston tops, turbocharger turbine wheels, and the like, may include a central axis, and a radial axis orthogonally extending from the central axis. During engine operation, these components are exposed to varying temperature along the radial axis. For instance, the piston top is exposed to a higher temperature near the central axis where combustion takes place, and a cooler temperature at an outer radius where the piston top slidingly engages a cylinder wall.

Thus, to increase durability, it is preferable that these components include more than one material placed along the radial axis. For example, the piston top may require a first material having a greater fatigue limit at a particular temperature near the central axis, along with a second material positioned nearer the outer radius having a lowered coefficient of thermal expansion. Nevertheless, it is customary to manufacture these components with a single metal-based material extending along the radial axis. Accordingly, engine system components made by currently accepted manufacturing practice may have less than optimal durability.

U.S. Pat. No. 5,972,071 (“Koike”) discloses a method of making a piston. More specifically, Koike discloses a method of making a piston by preparing a rapidly cooled metal powder, and subsequently extruding this rapidly cooled powder into a billet. The billet is subsequently cut to form a blank, and the blank is then sintered to form a coherent solid. Next, the sintered blank is forged to make the piston. Koike discloses that its piston includes a single material along its radial axis.

The present disclosure is directed to overcoming one or more problems set forth above and/or other problems associated with the prior art.

### SUMMARY

In accordance with one aspect of the present disclosure, a method of making an engine system component is disclosed. The method may include loading a first metal-based material and a second metal-based material into an extrusion chamber. The first metal-based material may concentrically surround the second metal-based material, and the first metal-based material may have at least one of a thermal property and a wear resistance different than the second metal-based material. The method may additionally include forming an extrudate by simultaneously passing the first metal-based material and the second metal-based material through a die. The first metal-based material of the extrudate may be metallurgically bonded to the second metal-based material of the extrudate. The method may also include forging the extrudate.

In accordance with another aspect of the present disclosure, a method of making a piston is disclosed. The method may include loading a first metal-based material and a second metal-based material into an extrusion chamber. The first metal-based material may concentrically surround the second metal-based material. The first metal-based material may have at least one of a lower coefficient of thermal expansion and a higher wear resistance than the second metal-based material, and the first metal-based material may have a lower fatigue limit at a particular temperature than the second metal-based material. The method may further include forming an extrudate by simultaneously passing the first metal-based material and the second metal-based material through a die. The first metal-based material of the extrudate may be metallurgically bonded to the second metal-based material of the extrudate. The method may further include forging the extrudate into a piston top. The piston top may include a crown and a ring belt concentrically surrounding the crown, and the ring belt may comprise the first metal-based material and the crown may comprise the second metal-based material. Subsequently, the piston top may be friction welded to a piston bottom.

In accordance with another embodiment of the present disclosure, a method of making a turbocharger turbine wheel is disclosed. The method may include loading a first metal-based material and a second metal-based material into an extrusion chamber. The first metal-based material may concentrically surround the second metal-based material. The first metal-based material may have at least one of a higher coefficient of thermal expansion, a higher wear resistance, and a lower thermal conductivity than the second metal-based material. Further, the first metal-based material may have a greater fatigue limit at a particular temperature than the second metal-based material. The method may also include forming an extrudate by simultaneously passing the first metal-based material and the second metal-based material through a die. The first metal-based material of the extrudate may be metallurgically bonded to the second metal-based material of the extrudate. The method may also include forging the extrudate into the turbocharger turbine wheel. The turbocharger turbine wheel may include an inner portion and an outer portion concentrically surrounding the inner portion. The outer portion may comprise the first metal-based material and the inner portion may comprise the second metal-based material.

These and other aspects and features of the present disclosure will be more readily understood when read in conjunction with the accompanying drawings.

### BRIEF DESCRIPTION

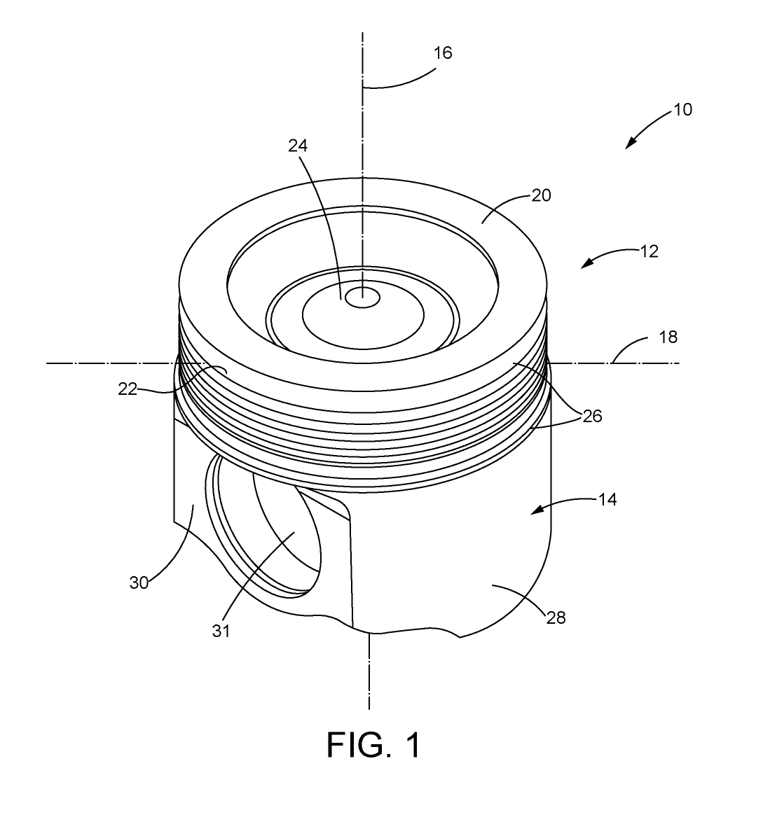

FIG. 1 is a perspective view of a piston that may be manufactured in accordance with the methods of making an engine system component disclosed herein.

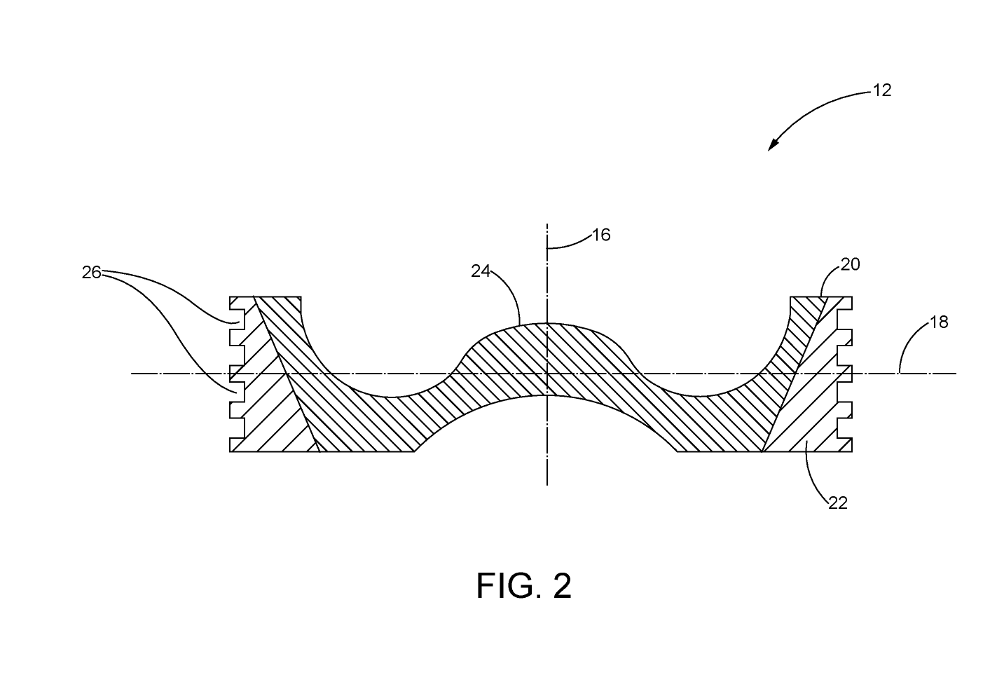

FIG. 2 is a cross-sectional view of the piston top of FIG. 1 that may be manufactured in accordance with the methods of making an engine system component disclosed herein.

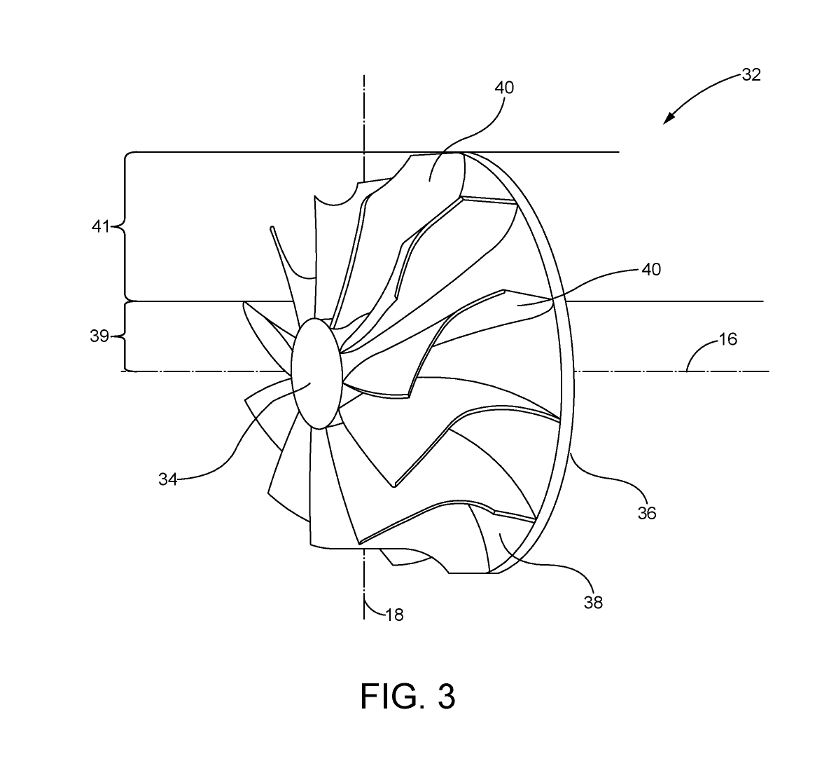

FIG. 3 is a perspective view of a turbocharger turbine wheel that may be manufactured in accordance with the methods of making an engine system component disclosed herein.

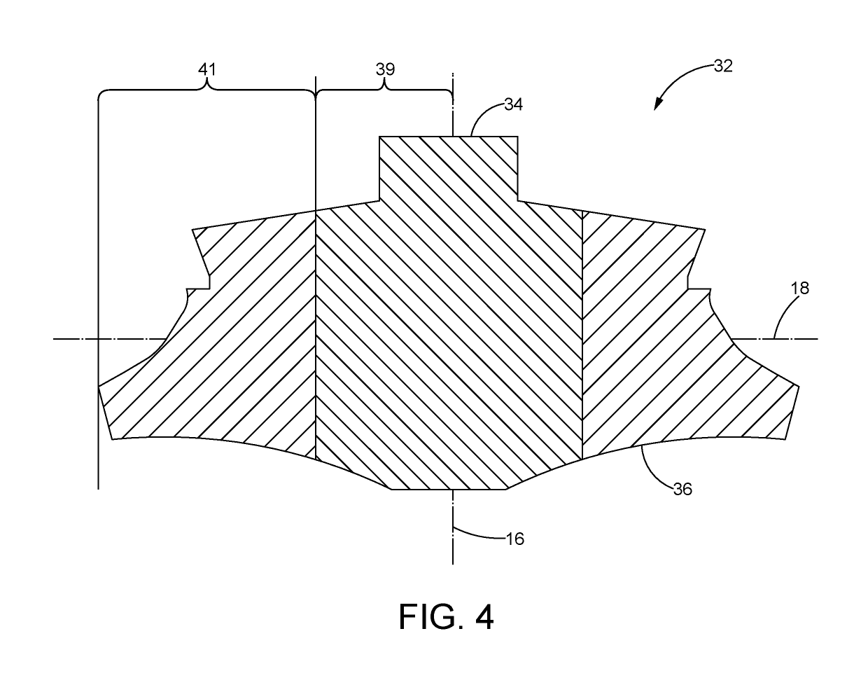

FIG. 4 is a cross-sectional view of the turbocharger turbine wheel of FIG. 3 that may be manufactured in accordance with the methods of making an engine system component disclosed herein.

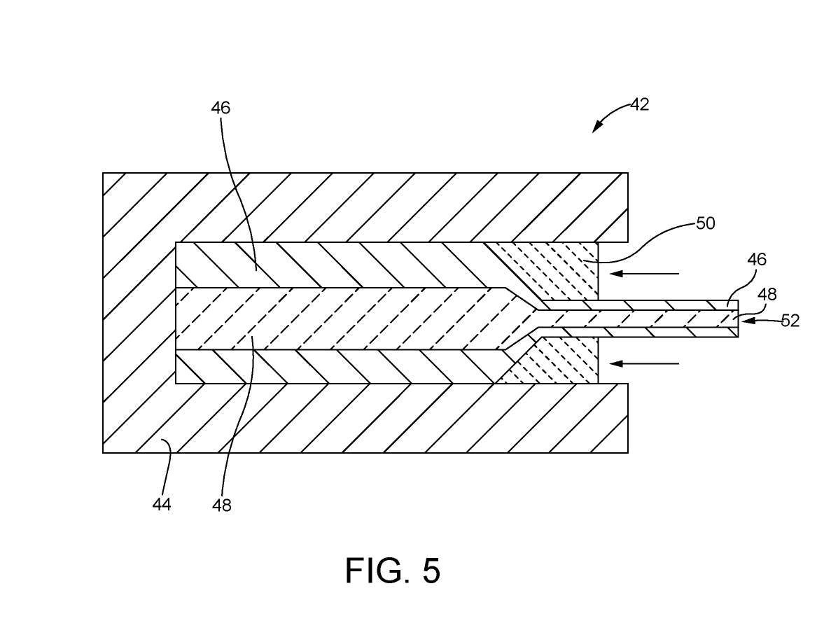

FIG. 5 is a cross-sectional view of an extrusion device that may be utilized to make engine system components manufactured in accordance with the methods disclosed herein.

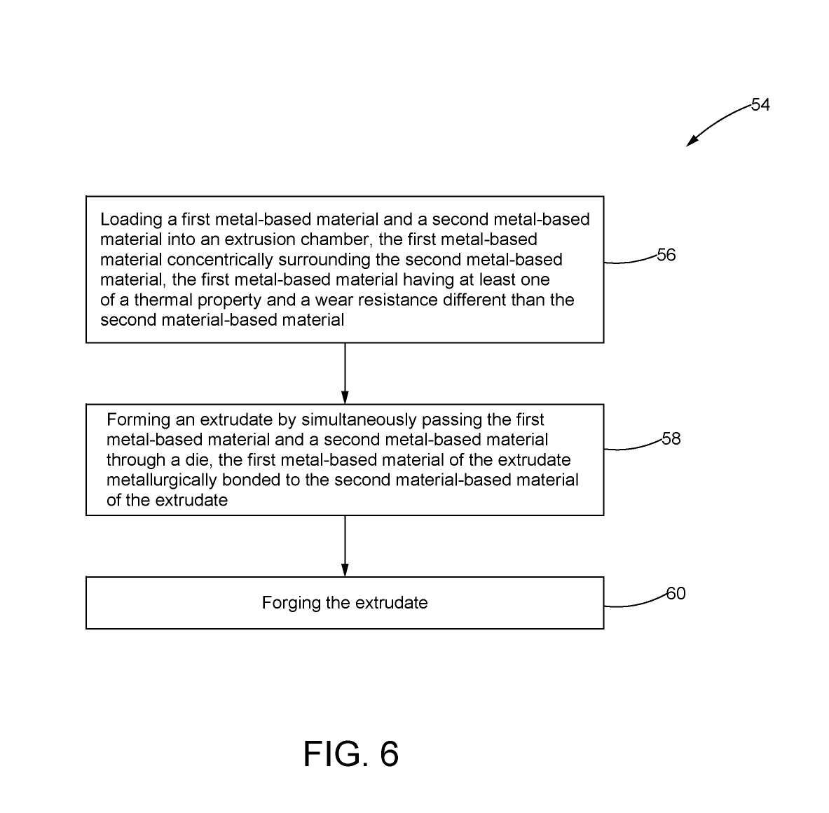

FIG. 6 is a flowchart illustrating exemplary steps of a method to manufacture engine system components in accordance with the present disclosure.

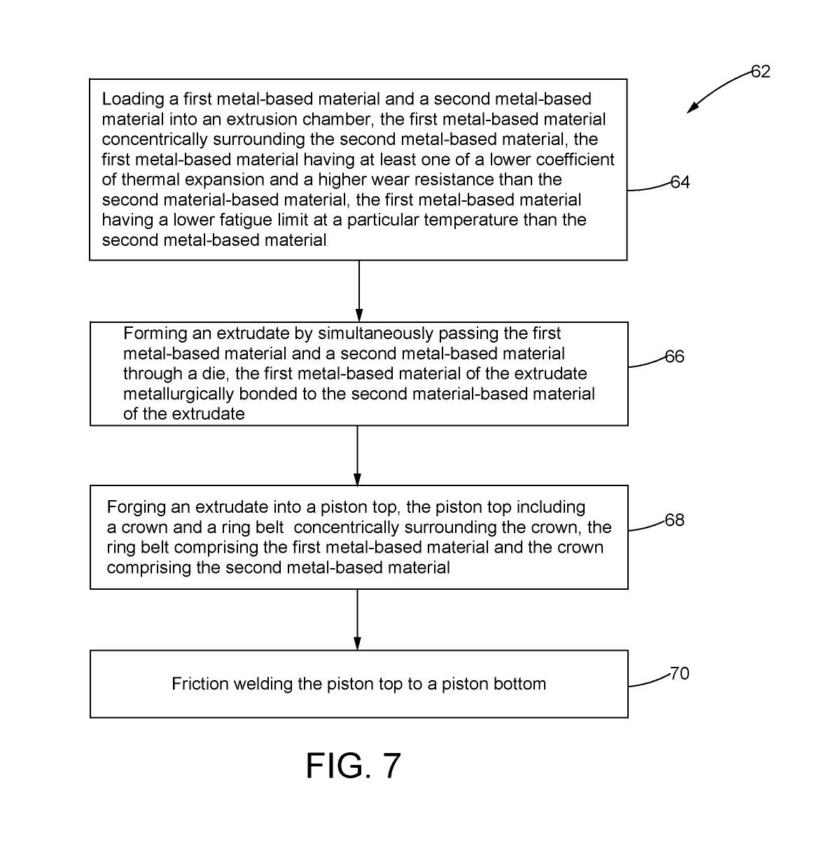

FIG. 7 is a flowchart demonstrating exemplary steps of a method to manufacture the piston of FIG. 1.

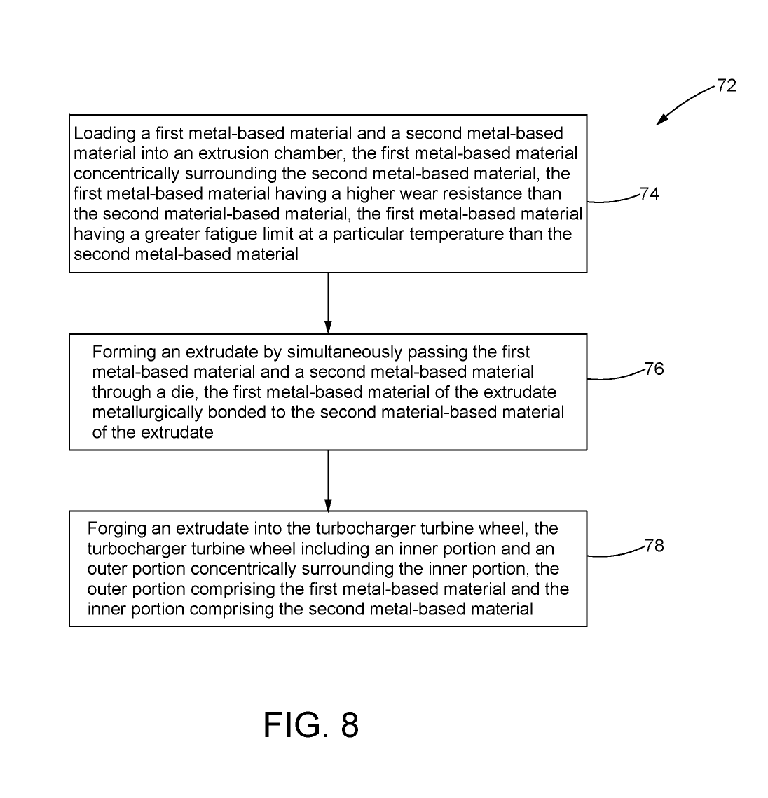

FIG. 8 is a flowchart depicting exemplary steps of a method to manufacture the turbocharger turbine wheel of FIG. 3.

### DETAILED DESCRIPTION OF THE DISCLOSURE

Various aspects of the disclosure will now be described with reference to the drawings, wherein like reference numbers refer to like elements, unless specified otherwise. Referring now to the drawings and with specific reference to FIG. 1, a piston 10 that may be manufactured in accordance with the methods of making an engine system component of the present disclosure is illustrated. The piston 10 may include a piston top 12 and piston bottom 14. A central axis 16 may extend through the piston top 12 and the piston bottom 14, while a radial axis 18 may extend through the piston top 12 and the piston bottom 14 as well. The radial axis 18 may extend orthogonally from the central axis 16.

As is shown in both FIGS. 1 and 2, the piston top 12 may include a crown 20 and a ring belt 22 concentrically surrounding the crown 20. A combustion bowl 24 may inwardly extend into the crown 20 and act as a primary location where combustion occurs. The ring belt 22 may include a plurality of piston ring grooves 26 traversing the circumference of the ring belt 22, and each of the plurality of piston ring grooves 26 may be configured to secure a piston ring.

The piston bottom 14 may include a skirt 28 downwardly extending from the piston top 12 and be configured to slidingly engage a cylinder wall. The piston bottom 14 may also include a side wall 30 through which a pin bore 31 is located. A gudgeon pin may be placed through the pin bore 31 to operatively connect the piston 10 to a connecting rod. The piston top 12 may be friction welded to the piston bottom 14.

FIG. 3 is a perspective view of a turbocharger turbine wheel 32 manufactured in accordance with methods of making engine system components disclosed herein. As depicted, the turbocharger turbine wheel 32 may include a front side 34 and a back side 36 opposite the front side 34. A body 38 may extend between the front side 34 and the back side 36. A plurality of vanes 40 may outwardly extend from the body 38 and be configured to engage an exhaust stream passing through a turbocharger.

As depicted in FIGS. 3 and 4, a central axis 16 may extend through the front side 34 and the back side 36, and the turbocharger turbine wheel 32 may be configured to rotate around the central axis 16. The turbocharger turbine wheel 32 may additionally include a radial axis 18 orthogonally extending from the central axis 16 through the body 38. In addition, the turbocharger turbine wheel 32 may include an inner portion 39 and an outer portion 41 concentrically surrounding the inner portion 39. While the turbocharger turbine wheel 32 depicted herein is for a radial turbine, it is certainly possible that the methods disclosed herein apply equally as well to a turbocharger turbine wheel 32 for an axial turbine.

Turning to FIG. 5, a cross-sectional view of an extrusion device that may be utilized to manufacture engine systems components in accordance with the methods disclosed herein is depicted, and is generally referred to by reference numeral 42. As seen therein, the extrusion device 42 may include an extrusion chamber 44 configured to receive a first metal-based material 46 and a second metal-based material 48, and the first metal-based material 46 may concentrically surround the second metal-based material 48. Additionally, the extrusion device 42 may include a die 50, and the first metal-based material 46 and the second metal-based material 48 may be simultaneously passed through the die 50 to form an extrudate 52. Moreover, after passing through the die 50, the first metal-based material 46 of the extrudate 52 may be metallurgically bonded to the second metal-based material 48 of the extrudate 52. While FIG. 4 depicts an indirect extrusion style device, it is certainly possible that another style of extrusion device 42 may be used, such as direct, or hydrostatic.

### INDUSTRIAL APPLICABILITY

In general, the present disclosure may find applicability in many industries including, but not limited to, automobiles, on-highway trucks, and off-highway trucks, and more particularly, to methods of making engine system components utilized in these industries. Although applicable to any engine system component, the present disclosure may be particularly applicable to engine system components exposed to varying temperature along their radial axis. As previously described, it is preferable that these components include more than one material placed along their radial axis to increase their durability. Nevertheless, it is customary to manufacture these components with a single material extending along this axis. The present disclosure finds usefulness by creating engine system components including more than one material along the radial axis, and as consequence, components having increased durability.

One exemplary method of making an engine system component 54 is depicted in the flowchart of FIG. 6. As shown, the method may include loading the first metal-based material 46 and the second metal-based material 48 into the extrusion chamber 44 of the extrusion device 42 at block 56. The first metal-based material 46 may concentrically surround the second metal-based material 48.

As discussed above, the first metal-based material 46 may be different than the second metal-based material 48. Accordingly, the first metal-based material 46 may have different material properties than the second metal-based material 48. These differing material properties include, but are not limited to, coefficient of thermal expansion, wear resistance, fatigue limit at a particular high temperature, thermal conductivity, and the like. Some examples of the first metal-based material 46 and the second metal-based material 48 that may be utilized to make engine system components in accordance with the present disclosure include, metals such as aluminum, magnesium, copper, titanium, and nickel. Additionally, the first metal-based material 46 and the second metal-based material 48 may be an alloy, such as, steel, AA8009, RSA8009, Al—Ti₃—Zr₂, Al—Cr₅—Zr₂—Mn₁, Al—Cr₆—Fe_{2.3}—TiO_{0.4}—SiO_{0.7}, AA4019, RSA4019, RSP461, RSA462, AA4032, and AA332. The first metal-based material 46 and the second metal-based material 48 may be a superalloy including HASTELLOY, INCONEL, WASPALOY, RENE alloys, HAYNES alloys, and the like. Other metals and alloys are certainly possible.

The first metal-based material 46 and the second metal-based material 48 may take on different forms. For example, the first metal-based material 46 and the second metal-based material 48 may both be a free-flowing powder. Alternatively, the first metal-based material 46 and the second metal-based material 48 may both be a free-flowing flake. In another instance, the first metal-based material 46 may be a free-flowing powder and the second metal-based material 48 may be a free-flowing flake, and vice versa. The free-flowing powder and the free-flowing flake may be cold-pressed before loading into the extrusion chamber 44. Further, in another example, the first metal-based material 46 and the second metal-based material 48 may be an extruded material. The extruded material may be mixed and matched with free-flowing powder and flake materials, as needed.

At block 58, an extrudate 52 may be formed by simultaneously passing the first metal-based material 46 and the second metal-based material 48 through the die 50 of the extrusion device 42. After passing through the die 50, the first metal-based material 46 of the extrudate 52 may be metallurgically bonded to the second metal-based material 48 of the extrudate 52. Further, after passing through the die 50, the extrudate 52 may be a coherent solid, thus not requiring any additional heating or sintering steps before undertaking further steps to make the engine system component described herein. At block 60, the extrudate 52 may be forged, such as by hot or warm die-forging, into the engine system component described herein. Before forging, however, the extrudate 52 may be cut into a near net size.

A method of making a piston 62, such as the one depicted in FIGS. 1 and 2, is illustrated in the flowchart of FIG. 7. As depicted at block 64, the method may include loading a first metal-based material 46 and a second metal-based material 48 into the extrusion chamber 44 of the extrusion device 42. The first metal-based material 46 may concentrically surround the second metal-based material 48.

As discussed before, the piston 10 may experience varying temperature along its radial axis 18. For example, the piston top 12 is exposed to a higher temperature near the central axis 16 where combustion takes place, and a cooler temperature at an outer radius where the piston top 12 slidingly engages a cylinder wall. Accordingly, the first metal-based material 46 may have at least one of a lower coefficient of thermal expansion and higher wear resistance than the second metal-based material 48. Example first metal-based materials 46 that may be utilized in this instance include, but are not limited to, AA4019, RSA4019, RSA461, and RSA462. Further, the second metal-based material 48 may have a greater fatigue limit at a particular temperature than the first metal-based material 46. Some examples of second metal-based materials 48 that may be used in this instance include steel, AA8009, RSA8009, Al—Ti₃—Zr₂, Al—Cr₅—Zr₂—Mn₁, and Al—Cr₆—Fe_{2.3}—TiO_{0.4}—SiO_{0.7}. It is certainly possible to utilize other materials.

The first metal-based material 46 and the second metal-based material 48 utilized to make the piston 10 may take on different forms. For example, the first metal-based material 46 and the second metal-based material 48 may both be a free-flowing powder. Alternatively, the first metal-based material 46 and the second metal-based material 48 may both be a free-flowing flake. In another instance, the first metal-based material 46 may be a free-flowing powder and the second metal-based material 48 may be a free-flowing flake, and vice versa. The free-flowing powder and the free-flowing flake may be cold-pressed before loading into the extrusion chamber 44. Further, in another example, the first metal-based material 46 and the second metal-based material 48 may be an extruded material. The extruded material may be mixed and matched with free-flowing powder and flake materials, as needed.

As depicted at block 66, an extrudate 52 may then be formed by simultaneously passing the first metal-based material 46 and the second metal-based material 48 through the die 50 of the extrusion device 42. After passing through the die 50, the first metal-based material 46 of the extrudate 52 may be metallurgically bonded to the second metal-based material 48 of the extrudate 52. Further, after passing through the die 50, the extrudate 52 may be a coherent solid, thus not requiring any additional heating or sintering steps before undertaking added steps to make the piston 10 described herein.

At block 68, the extrudate 52 may be forged, such as by hot or warm die-forging, into the piston top 12. The piston top 12 may include a crown 20 and a ring belt 22 concentrically surrounding the crown 20, and the ring belt 22 may comprise the first metal-based material 46 and the crown 20 may comprise the second metal-based material 48. Before forging, however, the extrudate 52 may be cut into a near net size. Finally, as is shown at block 70 the piston top 12 may be joined to the piston bottom 14, such as by friction welding.

FIG. 8 is a flowchart depicting an exemplary sequence of steps for making a turbocharger turbine wheel 72, such as the one depicted in FIGS. 3 and 4. As illustrated at block 74, the method may include loading a first metal-based material 46 and a second metal-based material 48 into the extrusion chamber 44 of the extrusion device 42. The first metal-based material 46 may concentrically surround the second metal-based material 48.

Like the piston 10, the turbocharger turbine wheel 32 may also experience varying temperature along its radial axis 18. For example, the turbocharger turbine wheel 32 may be exposed to a cooler temperature near its central axis 16 where exhaust gas exits a turbocharger, and a higher temperature closer to its outer radius where exhaust gas exits a volute and impinges on the plurality of vanes 40. Accordingly, the first metal-based material 46 may have a greater fatigue limit at a particular temperature than the second metal-based material 48. Some examples of first metal-based materials 46 that may be used in this instance include HASTELLOY, INCONEL, WASPALOY, RENE alloys, HAYNES alloys, and the like. Other materials are certainly possible. Further, the second metal-based material 48 may have a lower coefficient of thermal expansion than the first metal-based material 46. Example second metal-based materials 48 that may be utilized in this instance include, but are not limited to, steel, AA4019, RSA4019, RSA461, and RSA462. It is certainly possible to utilize other second metal-based materials 48 when manufacturing the turbocharger turbine wheel 32 in accordance with the methods disclosed herein.

The first metal-based material 46 and the second metal-based material 48 utilized to make the turbocharger turbine wheel 32 may take on different forms. For example, the first metal-based material 46 and the second metal-based material 48 may both be a free-flowing powder. Alternatively, the first metal-based material 46 and the second metal-based material 48 my both be a free-flowing flake. In another instance, the first metal-based material 46 may be a free-flowing powder and the second metal-based material 48 may be a free-flowing flake, and vice versa. The free-flowing powder and the free-flowing flake may be cold-pressed before loading into the extrusion chamber 44. Further, in another example, the first metal-based material 46 and the second metal-based material 48 may be an extruded material. The free-flowing powder and flake materials may be mixed and matched with the extruded material as needed.

As is depicted at block 76, an extrudate 52 may then be formed by simultaneously passing the first metal-based material 46 and the second metal-based material 48 through the die 50 of the extrusion device 42. After passing through the die 50, the first metal-based material 46 of the extrudate 52 may be metallurgically bonded to the second metal-based material 48 of the extrudate 52. Further, after passing through the die 50, the extrudate 52 may be a coherent solid, thus not requiring any additional heating or sintering steps before undertaking further steps to make the turbocharger turbine wheel 32 described herein.

Finally, at block 78, the extrudate 52 may be forged, such as by hot or warm die-forging, into the turbocharger turbine wheel 32. The turbocharger turbine wheel 32 may include an inner portion 39 and an outer portion 41 concentrically surrounding the inner portion 39. The outer portion 41 may comprise the first metal-based material 46 and the inner portion 39 may comprise the second metal-based material 48. Before forging, however, the extrudate 52 may be cut into a near net size.

The above description is meant to be representative only, and thus modifications may be made to the embodiments described herein without departing from the scope of the disclosure. Thus, these modifications fall within the scope of present disclosure and are intended to fall within the appended claims.

What is claimed is:

1. A method of making an engine system component, comprising:
loading a first metal-based material and a second metal-based material into an extrusion chamber, the first metal-based material concentrically surrounding the second metal-based material, the first metal-based material having at least one of a thermal property and a wear resistance different than the second metal-based material;
forming an extrudate by simultaneously passing the first metal-based material and the second metal-based material through a die, the first metal-based material of the extrudate metallurgically bonded to the second metal-based material of the extrudate; and
forging the extrudate.

2. The method of making the engine system component according to claim 1, wherein the first metal-based material has at least one of a lower coefficient of thermal expansion and a higher wear resistance than the second metal-based material, and further wherein the first metal-based material has a lower fatigue limit at a particular temperature than the second metal-based material.

3. The method of making the engine system component according to claim 1, wherein the first metal-based material has at least one of a higher coefficient of thermal expansion and a lower wear resistance than the second metal-based material, and further wherein the first metal-based material has a greater fatigue limit at a particular temperature than the second metal-based material.

4. The method of making the engine system component according to claim 1, wherein loading includes a free-flowing powder first metal-based material and a free-flowing powder second metal-based material.

5. The method of making the engine system component according to claim 1, wherein loading includes a free-flowing flake first metal-based material and a free-flowing flake second metal-based material.

6. The method of making the engine system component according to claim 1, wherein loading includes an extruded first metal-based material and a free-flowing powder second metal-based material.

7. The method of making the engine system component according to claim 1, wherein loading includes an extruded first metal-based material and a free-flowing flake second metal-based material.

8. The method of making the engine system component according to claim 1, wherein loading includes a free-flowing powder first metal-based material and an extruded second metal-based material.

9. The method of making the engine system component according to claim 1, wherein loading includes a free-flowing flake first metal-based material and an extruded second metal-based material.

10. The method of making the engine system component according to claim 1, wherein loading includes an extruded first metal-based material and an extruded second metal-based material.

11. The method of making the engine system component according to claim 1, wherein loading includes a cold-pressed first metal-based material.

12. The method of making the engine system component according to claim 1, wherein loading includes a cold-pressed second metal-based material.

13. A method of making a piston, comprising:
loading a first metal-based material and a second metal-based material into an extrusion chamber, the first metal-based material concentrically surrounding the second metal-based material, the first metal-based material having at least one of a lower coefficient of thermal expansion and a higher wear resistance than the second metal-based material, the first metal-based material having a lower fatigue limit at a particular temperature than the second metal-based material;
forming an extrudate by simultaneously passing the first metal-based material and the second metal-based material through a die, the first metal-based material of the extrudate metallurgically bonded to the second metal-based material of the extrudate;
forging the extrudate into a piston top, the piston top including a crown and a ring belt concentrically surrounding the crown, the ring belt comprising the first metal-based material and the crown comprising the second metal-based material; and
friction welding the piston top to a piston bottom.

14. The method of making the piston according to claim 13, wherein loading includes a free-flowing flake first metal-based material and a free-flowing flake second metal-based material.

15. The method of making the piston according to claim 13, wherein loading includes a free-flowing powder first metal-based material and a free flowing powder second metal-based material.

16. The method of making the piston according to claim 13, wherein loading includes a free-flowing flake first metal-based material and a free-flowing powder second metal-based material.

17. The method of making the piston according to claim 13, wherein loading includes a free-flowing powder first metal-based material and a free-flowing flake second metal-based material.

18. A method of making a turbocharger turbine wheel, comprising:
loading a first metal-based material and a second metal-based material into an extrusion chamber, the first metal-based material concentrically surrounding the second metal-based material, the first metal-based material having at least one of a higher wear resistance, a higher coefficient of thermal expansion and a lower thermal conductivity than the second metal-based material, the first metal-based material having a greater fatigue limit at a particular temperature than the second metal-based material;
forming an extrudate by simultaneously passing the first metal-based material and the second metal-based material through a die, the first metal-based material of the extrudate metallurgically bonded to the second metal-based material of the extrudate; and
forging the extrudate into the turbocharger turbine wheel, the turbocharger turbine wheel including an inner portion and an outer portion concentrically surrounding the inner portion, the outer portion comprising the first metal-based material and the inner portion comprising the second metal-based material.

19. The method of making the turbocharger turbine wheel according to claim 18, wherein loading includes a free-flowing flake first metal-based material and a free-flowing flake second metal-based material.

20. The method of making the turbocharger turbine wheel according to claim 18, wherein loading includes a free-flowing powder first metal-based material and a free flowing powder second metal-based material.
